(19) United States
(12) Patent Application Publication
(10) Pub. No.: US 2008/0298366 A1
(43) Pub. Date: Dec. 4, 2008

(54) Agnostic Network Architecture

(75) Inventors: Madan Mohan R. Appiah, Redmond, WA (US); Amit Chatterjee, Hyderabad (IN); Samir Jain, Hyderabad (IN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/756,354

(22) Filed: May 31, 2007

(51) Int. Cl. H04L 12/56

(52) U.S. Cl. 370/392

(57) ABSTRACT

Procedures for agnostically redirecting WAN link communications for WAN link throughput optimization are described. In an example, a WAN communication, targeted to a remote resource, is redirected to a local port proxy. The local port proxy may enforce WAN link policy on the communication to optimize communication flows occurring over the physical WAN link thereby increasing the relative efficiency of the physical WAN link. A remote port proxy may be included for forwarding the communication to the target remote resource via a separate communication connection.

### BACKGROUND

While physical communication network infrastructure is added to address increasing amounts of communication traffic, the physical links may carry less than the projected amount of communication traffic. For example, bandwidth or, the amount of physical link throughput, may be reduced because of the way in which communications occur over the components forming the physical communication connection. These throughput issues may be exacerbated for organizations having remote locations. For example, consider a first location connected via a T1 connection (a T1 connection being a high speed multiplexed connection) to a second location. This situation may raise local area network (LAN) issues and wide area network (WAN) issues as communication traffic may flow between local (LAN) traffic, between the two remote locations (WAN) traffic, or combinations thereof. For example, an application which performs within expected parameters in a LAN environment may slow down WAN traffic or traffic occurring between the first and second remote locations due to inefficient communication. Thus, the communication may not be optimized for the WAN environment and the application is excessively consuming communication link throughput.

In addition to the application concerns, network administrators may wish to designate portions of the communication resources for certain tasks. For example, a portion of a communication link may be designated for electronic correspondence. Network administrators may wish to prioritize other communication to insure timely delivery. For example, a network administrator may wish to establish policies so some application sessions receive preferential communication treatment over other applications sessions.

### SUMMARY

Procedures for agnostically redirecting WAN link communications for WAN link throughput optimization are described. In an example, a WAN communication, targeted to a remote resource, is redirected to a local port proxy. The local port proxy may enforce WAN link policy on the communication to optimize communication flows occurring over the physical WAN link thereby increasing the relative efficiency of the physical WAN link. A remote port proxy may be included for forwarding the communication to the target remote resource via a separate communication connection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an environment in an exemplary implementation that may use technologies to optimize wide area network (WAN) throughput.

FIG. 2 is a flow diagram depicting a procedure in an exemplary implementation in which WAN link policy is enforced on a redirected WAN communication.

FIG. 3 is a flow diagram depicting a procedure in an exemplary implementation in which WAN link policy is enforced by designating TCP/IP parameters for the redirected communication.

FIG. 4 is a flow diagram depicting exemplary implementations of port proxy data flows.

### DETAILED DESCRIPTION

Overview

Accordingly, techniques are described to optimize WAN link throughput. In one or more implementations, systems are discussed in which application WAN communications are redirected though a port proxy for enforcing WAN link policy on the communication session. Thus, while auto tuning may be used for optimizing Transmission Control Protocol (TCP)/Internet Protocol (IP) (TCP/IP) data transfers (transport and routing layers), the techniques and structures discussed herein may allow for increased WAN link throughput from the application perspective. For example, a client communication may be rerouted, through a local port proxy, so that WAN link throughput may be optimized. The redirecting may be implemented such that, the intervening structures and techniques are transparent to local client and remote resource.

In implementations, techniques are described in which a communication is redirected from the intended remote resource to a local port proxy. The local port proxy may enforce a WAN link policy on the communication. For example, enforcing a WAN link policy may maximize WAN link throughput and prioritization of the application communications. The session communications may be transferred to a corresponding remote location port proxy. A separate TCP connection may be used to communicate the data between the remote port proxy and the target remote resource. In this manner, the client application and target remote resource are unaware of the intervening architecture which may optimize communication over the intervening physical WAN link.

In the following discussion, exemplary environments are first described that are operable to optimize WAN link throughput.

Exemplary Environment

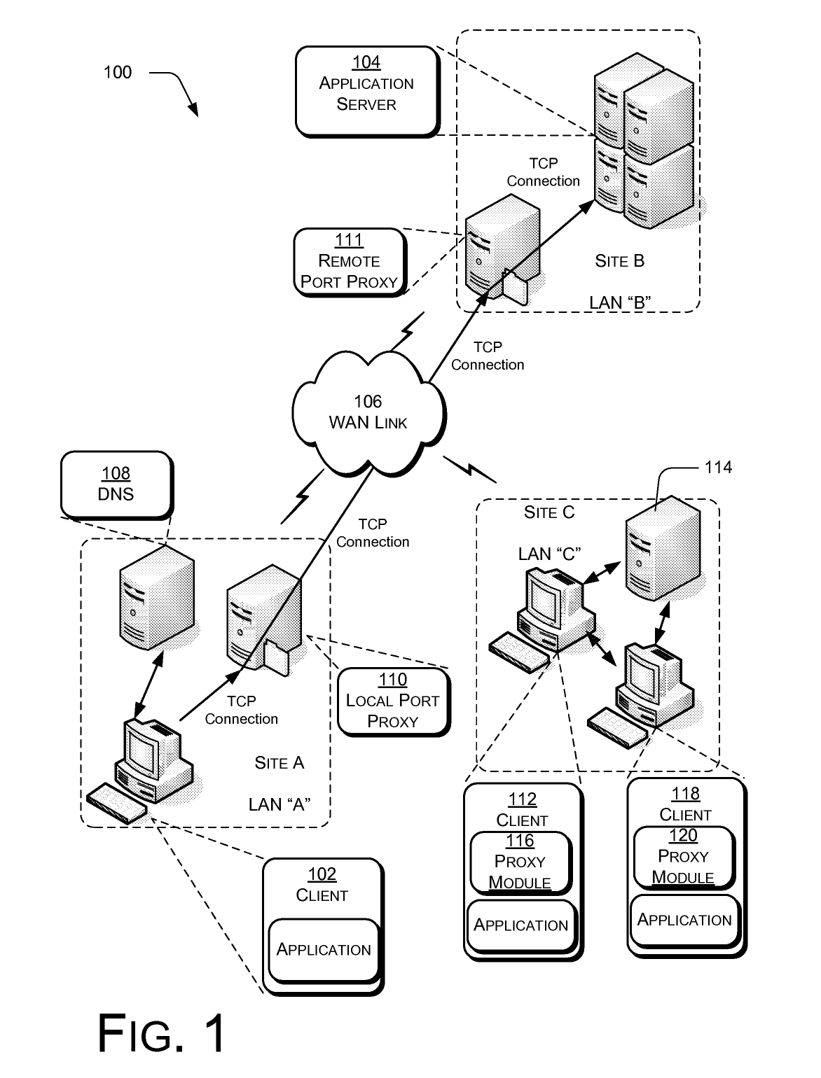

FIG. 1 illustrates an environment 100 in an exemplary implementation that is operable to employ redirection to optimize WAN link throughput in an agnostic manner. For example, optimization may result in greater throughput in comparison to a system in which WAN communications pass between the client and the remote resource. The architecture and techniques may permit redirection of WAN communications in a mixed local area network (LAN)/WAN environment.

For example, a local client 102 at “Site A” initiates a WAN communication with a remote resource (e.g., application server 104). In this situation, the local client 102 may operate in a LAN environment (within “Site A”), the WAN environment (with resources at “Site B”) or combinations thereof. For example, the “sites” may be organization branch offices connected by a fiber optic T1 WAN link 106. Other physical connections may be available as well.

The local client device may request a name lookup for the intended target. For example, the client device (i.e., the local client 102) directs a local domain name server (DNS 108) lookup the IP address of the remote resource. In response, the local DNS 108 returns the local port proxy IP address instead of the IP address of the target remote resource. For example, the remote resource IP address is included in a lookup table specifying the IP address of a local port proxy instead of the IP address of the remote application server 104. In this manner, the local device and the target remote resource may be “spoofed”, with the local device and the target remote resource being unaware of the architecture intervening between them. Put differently, the intervening architecture may be “agnostic” as the local client 102 is unaware that the communication is flowing through the local port proxy 110 rather than to the specified remote target.

The client may send the communication to the local port proxy IP address. For example, the client communication may be redirected from the intended target to a proxy server IP address for communication across the link. In this manner, the local client 102 and the local port proxy 110 may establish a TCP connection for the data transfer with separate connections forwarding the data to the intended target. The local port proxy 110 may bind the LAN session (the client to local port proxy session) and the WAN session (the local port proxy 110 to remote port proxy 111). For example, the LAN session and WAN session may be bound as if one channel was used.

The port proxy may enforce WAN link policy on a per-session basis for the communication. Thus, the communication may be prioritized in accordance with network administrator policies on a course grain basis. For example, the network administrator may prioritize communications, over other WAN communications, based on session characteristics such as client IP address, application identifier, remote procedure call (RPC), universal unique identifier (UUI), and port number. Other examples include dedicating a portion of the WAN link throughput for email communications, file transfer protocol (FTP) communications, and so on.

The local port proxy 110 may enforce WAN link policy by changing socket buffer size, TCP stack buffers, defining TCP/IP parameters, and so on. For example, the socket buffer is varied depending on the amount of traffic over the WAN link 106.

In other implementations, WAN link policy may be based on physical WAN link use. For example, the port proxy may monitor WAN link use and adjust WAN link communications accordingly. For example, if the physical link is under utilized, the local port proxy 110 may parallelize the incoming local client data stream. Parallelizing may allow for faster data transfer rates. Once transferred, the multiple data streams may be merged into a single stream and passed on via another TCP connection.

The TCP/IP connection for the local client/local port proxy may be terminated at the port proxy. For example, the communication may be rerouted through intervening architecture (between the local client 102 and the remote resource) such as through the local port proxy 110. Thus, the client/local port proxy TCP connection is terminated at the local port proxy 110 with subsequent TCP connections established between intervening hardware. For example, a separate TCP connection is used between the local port proxy 110 and the remote port proxy 111, and a separate TCP connection is established between the remote port proxy 111 and the target remote resource.

The port proxy may translate application specific issues. For example, file transfer protocol (FTP), server message block (SMB) applications, or other applications may include port numbers and addressing within the application payload. In such instances, the local port proxy 110 may translate the payload portions, including porting and other application addressing issues. Thus, the designated local client IP address may be translated to the local port proxy IP address.

If the session is accepted, the communication may be transferred to the remote port proxy 111 in accordance with the applied WAN link policy. For example, if admission is available, the communication may pass to the remote port proxy 111 which in-turn establishes a TCP connection with the target remote resource. In contrast, if the WAN link 106 is busy, the communication may be buffered. Child sessions may be bound to the parent session with the parent session parameters enforced on the child session.

From the perspective of the remote resource, the remote resource may receive the remote port proxy session as if the communication originated with the remote port proxy 111. Correspondingly, the remote resource may communicate with the remote port proxy 111 via a TCP connection as if the remote port proxy 111 were the originating client. If parallelization has occurred, the remote port proxy 111 may recombine the application throughput for transfer to the remote resource.

In further implementations, a port proxy module may be included in a client device 112/remote resource for enforcing WAN link policy on redirected WAN communications. For example, a LAN DNS 114 may direct the WAN communications through a port proxy module 116 included in a client 112. In this implementation, the WAN communications may be managed through the client port proxy modules in a peer-to-peer (P2P) manner. Thus, the WAN transfers may be arbitrated among the clients 112 and 118 granted WAN access. Client port proxy modules 116 and 120 may optimize link throughput (e.g., make efficient use of the available physical transfer capacity) by enforcing WAN link policy in much the same manner as discussed above. The network administrator may enforce WAN link policy through the client resident proxy modules.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory storage devices, e.g., memory.

The following discussion describes transformation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

Exemplary Procedures

The following discussion describes methodologies that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. A variety of other examples are also contemplated.

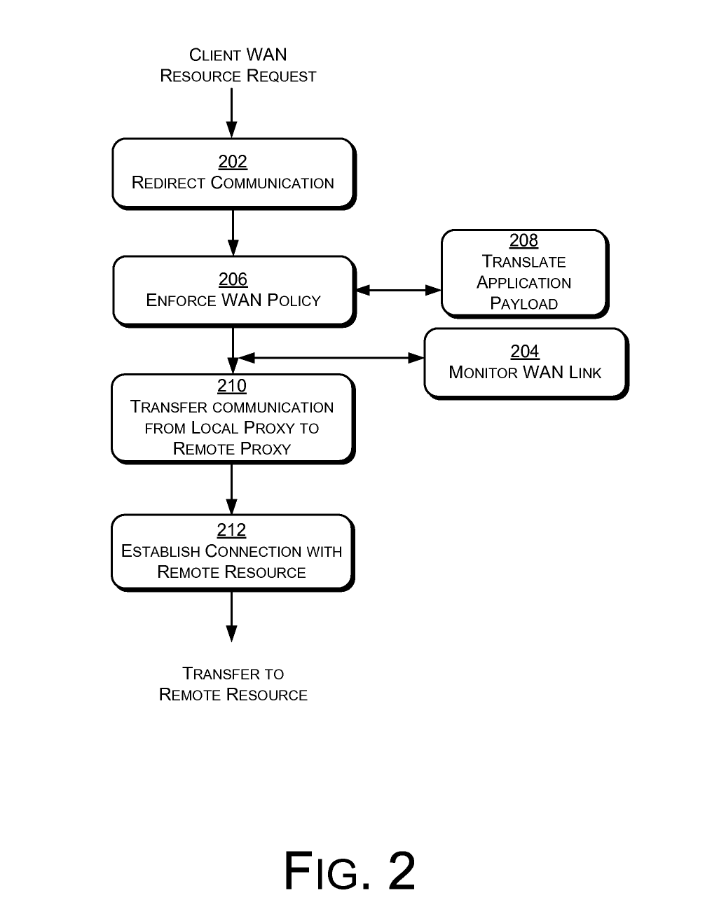

FIG. 2 discloses exemplary procedures for implementing agnostic WAN optimization. For example, WAN link throughput may be optimized to make more efficient use of the WAN link physical capacity in comparison to WAN links not operating in conformance with the present procedures. The procedures may be used to control WAN link throughput as desired. In the present procedure, a client communication may be redirected 202 from an intended remote resource to a local port proxy. For example, a communication with a remote application server is rerouted through a local port proxy and a remote port proxy associated with the target remote device.

In response to a name lookup request (such as for the remote application server), a local DNS may provide the IP address of a local port proxy, rather than the IP address of the target remote resource. Thus, a TCP connection may be formed between the client and the local port proxy with the data passing through the TCP/IP stack. While the TCP connection is terminated at the port proxy, a resultant WAN TCP connection may be bound to the local LAN TCP connection as a single channel.

The redirected communication may be passed through the port proxy in accordance with WAN link policy. For example, the communication may be prioritized based on the client IP address, the type of communication, monitored 204 WAN throughput and so on. The session TCP/IP parameters may be defined by the port proxy so that the session is transferred in accordance with the WAN link policy.

The WAN link policy may be enforced 206 on the communication. For example, the communication may be restricted based on the amount and priority of other WAN link communications, the client IP address, and so on. Enforcement 206 may include changing socket buffer sizes, changing buffer length, based on TCP/IP stack feedback, designating TCP/IP parameters, and so on. For example, a communication may be given a high priority (in comparison to other traffic) based on the client IP and port address. In other instances, the communication is prioritized based on the type of communication. For example, incoming email traffic may be restricted based on the current email traffic. In other instances, a portion of the WAN link throughput is designated for high priority traffic. Thus, the communication may be treated on a per session basis.

If desired, the application payload may be translated 208. For example, a client IP address and port number included in a file transfer protocol (FTP) application payload may be translated 208 to the IP address and port number for the port proxy. Subsequent TCP connections may be translated in a similar manner. For example, a remote port proxy may translate the application payload IP address and forward the communication, via a separate TCP connection, to the target remote resource with the IP address of the remote port proxy in place of the local port proxy IP address.

The local port proxy/remote port proxy communication may be transferred 210 in compliance with the enforced WAN link policy. For example, the communication is transferred 210 over the WAN link to a remote port proxy, included in a LAN encompassing the target remote resource, in agreement with the enforced WAN link policy. For example, while the session may be accepted for WAN link transfer, the resultant communication rate may be constrained to allow other communications over the link. Thus, data may flow at a lower rate in comparison to a link having fewer unrelated communications.

At the remote port proxy, a separate TCP connection may be established 212 with the intended remote resource. For example, the remote port proxy establishes 212 a LAN connection with an application server. If desired, the application payload may be translated so that IP address and port numbers are changed to match the IP address and port number for the remote port proxy. Thus, the intended resource may communicate with the remote port proxy as if the port proxy originated the communication. As a result, the remote resource may be “unaware” of the intervening architecture. Communications flowing from the remote resource to the local client may be performed in a substantially similar manner.

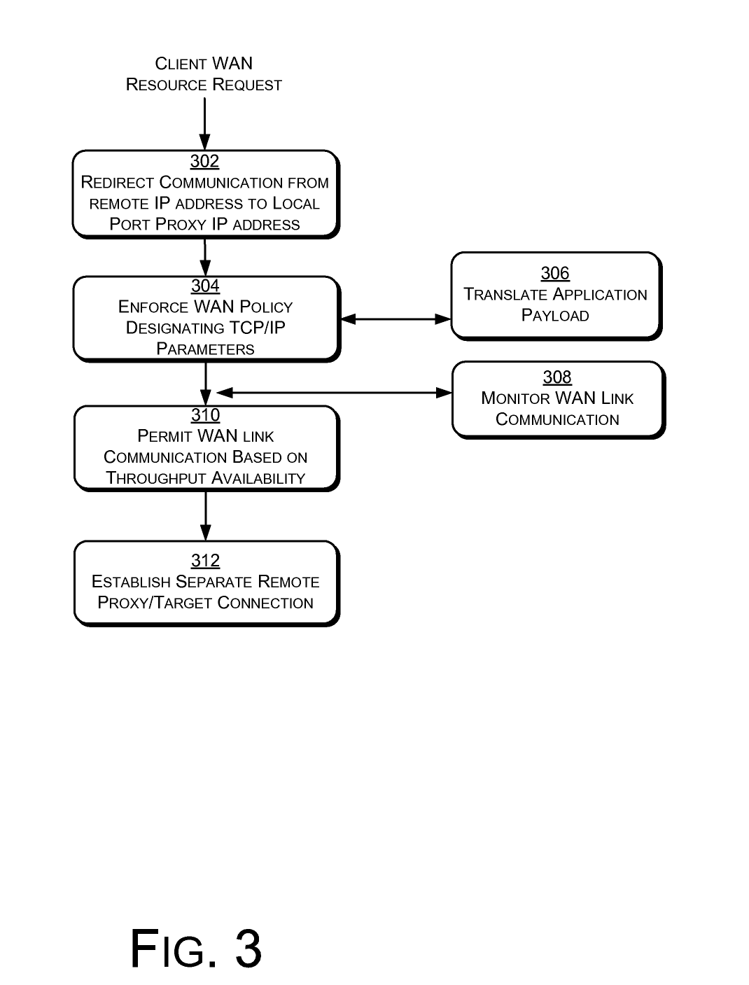

FIG. 3 discloses exemplary procedures for redirecting WAN communications for WAN link optimization. The procedures may allow WAN link throughput optimization based on the enforced WAN link policy in an agnostic manner. The WAN link may be optimized to make more efficient use of the WAN link physical capability in comparison to system not acting in conformance with the procedures discussed herein.

The client WAN communication may be redirected 302 from the intended remote resource to a local port proxy. For instance, a communication targeting a remote application server is rerouted to a local port proxy server. The communication may be redirected 302 by inserting the IP address of the local port proxy in place of the IP address of the intended target. In this way, the client/local port proxy TCP connection may be terminated at the local port proxy. Thus, the client may be “unaware” of the redirection. For example, a local DNS may return the IP address for the local port proxy in response to a name lookup for a remote application server. As a result, the communication may be passed through the local port proxy and a remote port proxy before reaching the intended remote resource.

The local port proxy may enforce 304 the WAN link protocol on the communication. For example, the session data flow may be constricted (in comparison to the rate at which the communication is typically transferred) as a result of the enforced WAN link protocol. WAN link protocol may be enforced by varying the TCP/IP parameters on the communication session. Therefore, a local port proxy may designate the TCP/IP parameters to optimize the WAN link throughput. Examples include permitting data flow parallelization, constricting data flow, changing socket buffer size, buffer length, and so on. For example, email communication is restricted so that email communication does not exceed a designated portion of the overall WAN link throughput. If WAN link throughput is available, data may be communicated in parallel to maximize WAN link use.

WAN link policy may be based on the client IP address, the type of communication, available bandwidth and so on. For example, a communication may be given a high priority, and transferred at a preferential rate, based on the client IP address.

If desired, the application payload may be translated 306 for redirection. For example, a client IP address and port number included in the application payload may be translated 306 to the IP address and port number for the port proxy. Subsequent TCP connections may be translated in a similar manner.

The WAN link may be monitored 308. Monitoring 308 may track the various WAN data transfers. For instance, the local port proxy may permit faster link communication if WAN link monitoring indicates the physical WAN link capacity is underutilized. Correspondingly, if monitoring indicates that the WAN link will become over utilized, the port proxy may adjust incoming session TCP/IP parameters and slow down data transfer rates.

The communication may be transferred to the remote port proxy in accordance with the enforced WAN link policy. For example, a communication is permitted 310 through the WAN link, if link is available, on a per session basis. The communication may be based on the available WAN link throughput. For instance, if the physical WAN link may accept the communication. The WAN link may accept the communication if the physical connect is capable of communicating the data.

A separate connection may be established 312 between the remote port proxy and the target device to forward the data between the remote port proxy and the intended remote resource. For example, a separate TCP connection is established for communicating data between the remote port proxy and the target remote resource.

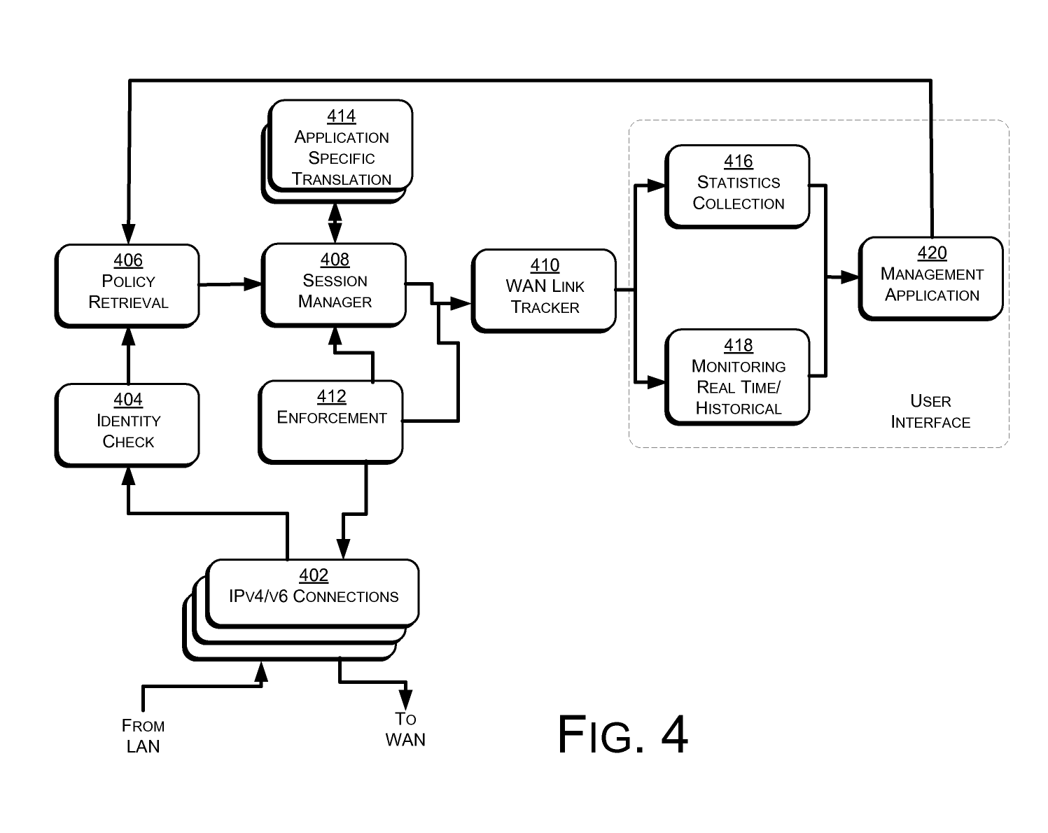

Referring to FIG. 4, exemplary port proxy techniques and data flows in implementations are discussed. The procedure discussed herein may be used in conjunction with the above techniques and systems. For example, a network administrator may control WAN link use by manipulating the port proxy policies in accordance with his/her preferences.

In implementations, the client communication is received from the LAN. The communication may be redirected from the target remote resource (included in a WAN with the requesting client). For example, the proxy receives a LAN client communication redirected from the remote resource. The packet supporting the session may enter the TCP/IP stack. For example, the TCP/IP stack receives IPv4/v6 addressed network layer data packets 402.

The identity of the client 404 may be determined for the incoming LAN session. For example, the client IP address is used for prioritizing WAN link transfer. For instance, the communication is prioritized as high, medium or low based on the client IP address.

The network administrator may configure the port proxy policy 406 based on session characteristics such as client IP address, server IP address, application identifiers such as port number, remote procedure call (RPC), universal unique identifier UUI), and so on. In further instances, the port proxy policy 406 is configured to optimize or prioritize throughput. For example, a session is parallelized over the WAN link. In other instances, the incoming LAN communication may be constrained if the communication is lower priority, such as if the client has a low priority IP address or the type of communication is of a type constrained to a specified bandwidth. An example of the latter situation may occur if transferring an email would cause the WAN link to exceed the specified bandwidth for email communications.

The LAN side TCP/IP session may be terminated at the port proxy. For example the LAN TCP/IP session is terminated as if the remote communication was transferred to the target. In this manner, the client may be unaware that the TCP/IP connection has been redirected through the local port proxy.

The port proxy policy 406 may be retrieved for the LAN session. The retrieved policy may be based on the available bandwidth and other session characteristics for the incoming LAN session. For example, policy retrieval may search the port proxy policy for the given session, so that the port proxy policy may be enforced for the session.

If the session is accepted by a session manager 408 (e.g., WAN bandwidth is available), the resultant WAN session and LAN session may be bound into one channel. For example, a session manager module binds the local client LAN communication (between the local client and the local port proxy) to the WAN communication (between the local port proxy and the remote port proxy). The session manager 408 may bind a child session with the parent session with the parent session parameters enforced on the child session.

A session manager may control WAN link data flow based on the WAN link availability as determined by the WAN link tracker 410. For example, the WAN link tracker monitors WAN link use so the session manager may enforce 412 port proxy policy based on the available throughput, network administrator policy, and so on. In other instances, the session manager may access the WAN link tracker 410 upon receiving a client communication. The communication may be forwarded over the WAN in compliance with the enforced port proxy policy.

The application may be translated 414, as desired. For example, a port number or IP address in the application payload are translated 414. For example, if the application is an FTP application, a client port number in the application payload may be translated 414 to a proxy port number. For example, the client IP address is translated into the IP address for the local port proxy so that the remote port proxy may communicate with the local port proxy as if the local port proxy is the client. Correspondingly, the remote port proxy may translate 414 an included IP address to reflect the IP address of the remote port proxy so that the return from the remote resource is directed to the remote port proxy. Thus, the translated port number may reflect the redirection of the WAN communication through the intervening architecture.

If applicable, the translated application resource may be forwarded over the WAN in compliance with the enforced port proxy policy. For example, a TCP/IP connection is established between the port proxy and a remote port proxy included in a remote LAN encompassing the original target remote resource. Enforcement may include defining TCP/IP parameters, changing socket buffer sizes, changing buffer length, mapping a session to other QoS schemes such as IP type of service (TOS), Institute of Electrical and Electronics Engineers IEEE 802.1p tagging (a specification for prioritizing network traffic), virtual LAN (VLAN) 802.1q tagging, and so on.

In further implementations, the WAN link tracker statistics may be sent for statistics collection 416 and monitoring 418. For example, the historical and real time statistics are presented via a user interface so a network administrator may adjust port parameters as desired. A management application 420 may update the policy retrieval in light of the reported statistics and monitoring.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
redirecting a wide area network (WAN) communication from an intended remote resource to a local port proxy;
enforcing WAN link policy on the WAN communication;
transferring the WAN communication via a WAN link from the local port proxy to a remote port proxy for the intended remote resource.

2. The method as described in claim 1, wherein transferring includes transferring the communication via a transmission control protocol (TCP)/internet protocol (IP) communication.

3. The method as described in claim 1, wherein enforcing includes changing transmission control protocol (TCP)/internet protocol (IP) parameters for a WAN communication session.

4. The method as described in claim 1, wherein enforcing is conducted on a per session basis.

5. The method as described in claim 1, further comprising establishing a connection between the remote port proxy and the intended remote resource.

6. The method as described in claim 1, wherein enforcing includes the local port proxy specifying a throughput for the WAN communication.

7. The method as described in claim 1, wherein enforcing is based on an internet protocol (IP) address of a client issuing the WAN communication.

8. The method as described in claim 1, further comprising translating an application payload internet protocol (IP) address to an IP address of the local port proxy.

9. The method as described in claim 1, further comprising monitoring WAN link traffic.

10. One or more computer-readable media comprising computer-executable instructions that, when executed, direct a computing system to,
redirect a communication from an intended remote resource internet protocol (IP) address to a local port proxy IP address;
enforce a wide area network (WAN) link policy including designating transmission control protocol (TCP)/IP parameters on the communication;
permit WAN link communication on a per session basis to a remote port proxy, based WAN link throughput availability.

11. The one or more computer-readable media as described in claim 10, wherein WAN link communication is parallelized based on WAN link throughput availability.

12. The one or more computer-readable media as described in claim 10, wherein enforcement includes at least one of changing socket buffer size or getting TCP stack feedback session parameters.

13. The one or more computer-readable media as described in claim 10, further comprising monitor WAN link communication.

14. The one or more computer-readable media as described in claim 10, wherein enforcement is based on at least one of a client IP address or port number.

15. The one or more computer-readable media as described in claim 10, wherein enforcement is conducted by a device issuing the communication.

16. A system comprising:
a local port proxy configured to enforce WAN link policy on a session for a redirected WAN communication; and
a remote port proxy configured to forward the redirect WAN communication from the local port proxy to an original target of the redirected WAN communication.

17. The system as described in claim 16, wherein enforcing WAN link policy includes at least one of specifying WAN link throughput, prioritizing the session, prioritizing the session based on socket buffer size or parallelizing the session.

18. The system as described in claim 16, wherein the remote port proxy merges parallelized WAN communication into a single data stream.

19. The system as described in claim 16, wherein the local port proxy enforces WAN link policy by defining session transmission control protocol (TCP)/internet protocol (IP) parameters.

20. The system as described in claim 16, wherein the local port proxy is a dedicated physical device.
